(19) United States
(12) Patent Application Publication
(10) Pub. No.: US 2003/0050036 A1
(43) Pub. Date: Mar. 13, 2003

(54) Security services for wireless devices

(76) Inventors: Matthew A. Hayduk, Calgary (CA); Chun-Xiang He, Calgary (CA)

Correspondence Address: Timothy N. Trop, TROP, PRUNER & HU, P.C., STE 100, 8554 KATY FWY, HOUSTON, TX, 77024-1805, US

(21) Appl. No.: 09/948,889

(22) Filed: Sep. 7, 2001

(51) Int. Cl. H04M 11/00

(52) U.S. Cl. 455/403; 455/410; 455/411

(57) ABSTRACT

A wireless system may include a separately accessible protocol stack and security services module. The security services module may handle cryptographic algorithms and other security services. Since the modules are separately accessible, the protocol stack may be developed, tested and updated independently of the security services module and vice versa.

### BACKGROUND

This invention relates generally to wireless communication devices, including cellular telephones, and particularly to the provision of security services for wireless devices.

Wireless communication devices, such as cellular telephones, include a wireless protocol stack that implements an appropriate wireless protocol such as code division multiple access (CDMA) or time division multiple access (TDMA) as two examples.

Conventional protocol stacks also provide security services. Security services include the cryptographic algorithms used for encryption, verification and authentication. The security services are generally embedded as part of the protocol stack.

In relatively simple applications, this arrangement may be suitable, especially where the security algorithms are infrequently utilized or where they are utilized only by a single entity. The approach becomes more problematic with new and more complex security algorithms such as Diffie Hellman, f8, and advanced encryption standard (AES) algorithms. It may become desirable to integrate independently developed and certified security algorithms as standards evolve.

In addition, the development and testing of the protocol stack may be complicated by including security algorithms. For one thing, the security algorithms may be subject to improvements and changes over time. Moreover, the security algorithms tend to be relatively complicated and thus increase the testing cycle for the entire protocol stack. Also, the ability to download upgrades to the security algorithms, for example over the Internet, is relatively limited when those algorithms are incorporated within the protocol stack.

Thus, there is a need for better ways to implement security services in wireless devices.

### BRIEF DESCRIPTION OF THE DRAWINGS

FIG. 1 is a schematic depiction of the software of a wireless system in accordance with one embodiment of the present invention;

FIG. 2 is a hardware depiction of the wireless system shown in FIG. 1 in accordance with one embodiment of the present invention; and

FIG. 3 is a flow chart for security services software in accordance with one embodiment of the present invention.

### DETAILED DESCRIPTION

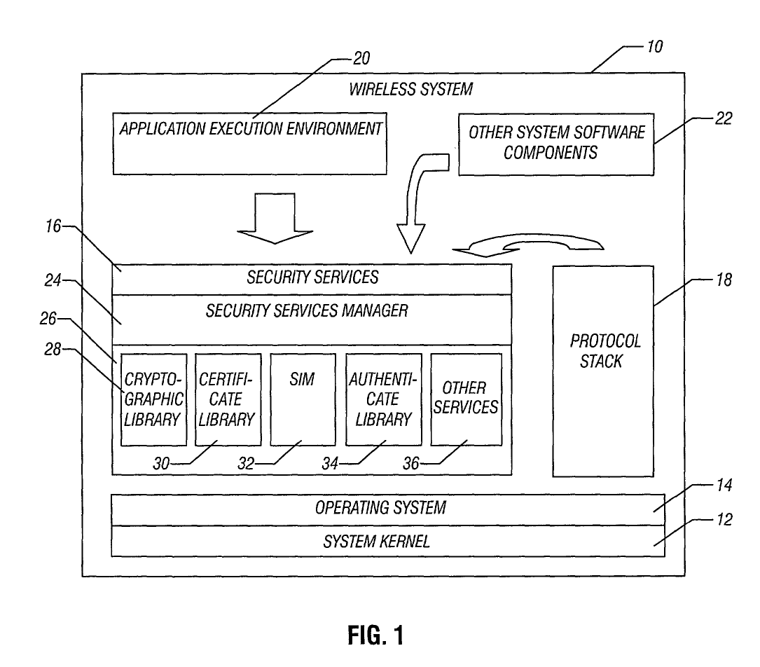

Referring to FIG. 1, a wireless system 10, which may be a cellular telephone that uses any applicable protocol including code division multiple access or time division multiple access, to mention two examples. The wireless system 10 may be a second generation, third generation or so called 2.5 generation wireless system, again to mention a few examples.

The wireless system 10 may include an application execution environment 20 and other software components 22. The application execution environment 20 and software components 22 interact with a security services module 16. The security services module 16 also interacts with the protocol stack 18 that implements the appropriate wireless protocol. Further down in the software levels, are an operating system 14 and a system kernel 12.

The security services module 16 may include a security services manager 24. The manager 24 may handle a plurality of modules or libraries 26. For example, a cryptographic library 28 may be utilized to provide the appropriate security algorithms such as the Diffie Hellman, f8, and advanced encryption standard algorithms, to mention a few examples. In addition, a certificate library 30 may contain information about digital certificates for applicable parties. A subscriber identity module (SIM) 32 may be provided to limit access to the wireless system 10 to only authorized subscribers. An authentication library 34 may be provided as may other services 36.

In one embodiment, the security services manager 24 may be in accordance with the Common Data Security Architecture Specification, Version 2 C914 ISBN 1-85912-202-May 7, 2000 published by Intel Corporation, Santa Clara, Calif. The libraries 26 may be in accordance with the common security services manager (CSSM), also provided as part of the aforementioned Intel specification. The CSSM enables tight integration of individual services while allowing those services to be provided by interoperable modules. The CSSM defines a rich, extensible application program interface to support the development of secure applications and system services as well as an extensible interface supporting add-in security modules that implement building blocks for secure operations. Security algorithms that are part of protocol standards may be implemented and may evolve through performance enhancements.

The CSSM allows the protocol stack 18 to bind with the CSSM for security services, simplifying the implementation of a stack 18 by removing direct security algorithm dependencies and allowing third party security algorithm support. In addition, new application security services may register with the CSSM to request the same service, allowing a single security service module to support multiple uses. With the addition of recognized priority, the recognition and priority of the algorithm execution may be set appropriately within the overall context of the system.

Thus, utilizing the CSSM layer, protocol stack 18 development may be simplified by off-loading the requirements for security services in some embodiments. As a result, stack implementation and testing cycle may be reduced in some embodiments. Moreover, in some embodiments, the security services may be more upgradable and may be amenable to updating over Internet downloadable applications.

In some embodiments, the specified CDSA system resources, including memory size and processing power, may make it difficult to port CDSA directly to embedded systems. In order to port CDSA into wireless embedded platforms, it may be desirable to only port a subset of the existing CDSA implementations that include the CSM core and required added-in security service modules. It may also be desirable to reconfigure the CDSA package to fit into the embedded platform. Some features such as dynamic binding and flexible extensibility may not be required in embedded systems that implement security services. Thus, in some embodiments, a trimmed down CDSA package may be developed that is suitable for use in embedded platforms.

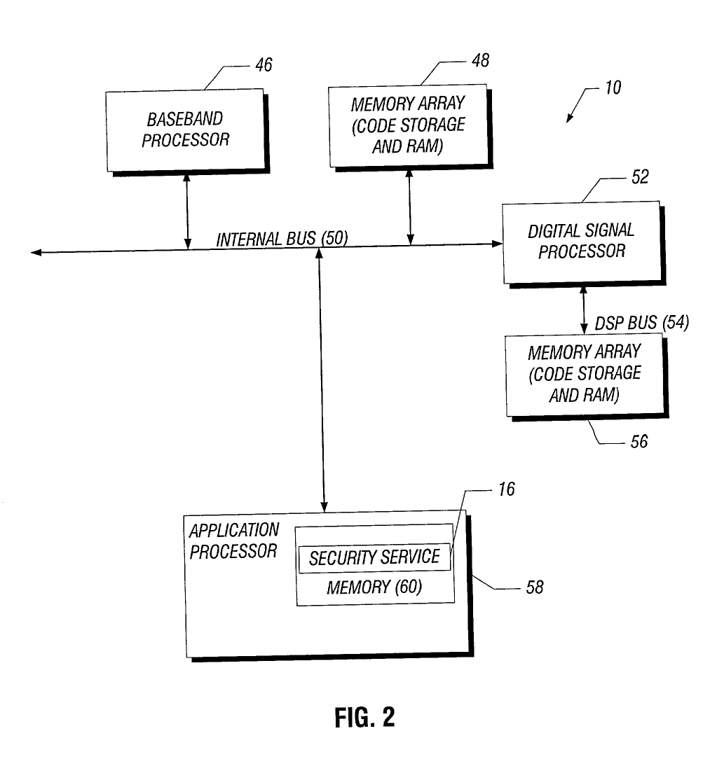

Referring to FIG. 2, the wireless system 10 may include an internal bus that supports a baseband processor 46 and a memory array 48. The memory array 48 may include code storage and random access memory (RAM). In one embodiment, the protocol stack may be stored in the memory array 48. The internal bus 50 also supports a digital signal processor (DSP) 52 which may have its own bus 54 and its own memory array 56 in some embodiments. In some embodiments, a separate application processor 58 may be provided with memory 60. In one embodiment, a security services software module 16 may be stored in the memory 60.

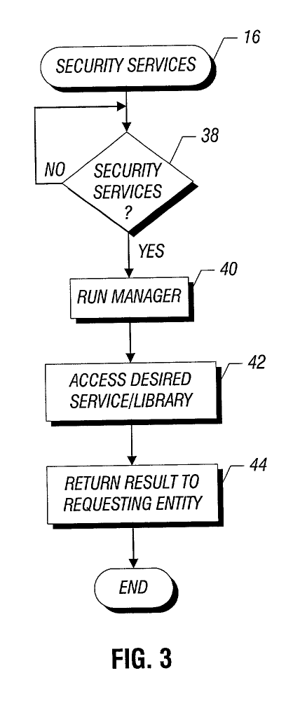

Referring to FIG. 3, the security services module 16 may be called to implement security services. For example, in one embodiment, the protocol stack 18 may handle communications services, but when security services such as authentication are needed in the course of communication services, the protocol stack 18 simply calls the security services module 16. Likewise, other software, such as the application execution environment 20 and the other system software components 22, may also call the security services module 16.

The security services module 16 checks, at diamond 38, to identify a request for security services. If there is a request, the security services manager 24 is run as indicated in block 40. The desired service or library can then be accessed within the libraries 26 as indicated in block 42. A result is then obtained and the result may then be returned to the appropriate requesting entity, such as the protocol stack 18, all as indicated in block 44.

The protocol stack 18 and security services module 16 may be stored on either of the memories 60 and 48. Alternatively, the protocol stack 18 and the security services module 16 may be stored in separate ones of the memories 60 and 48. All that is desirable is that the protocol stack 18 and security services module 16 be separately accessible, for example, so that the protocol stack can call the security services module 16.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A method comprising:
providing a protocol stack for wireless communications;
providing a security services module; and
enabling said module to be accessed separately from said stack.

2. The method of claim 1 including enabling the protocol stack to obtain security services from the security services module.

3. The method of claim 1 wherein providing security services includes providing encryption, verification, or authentication services.

4. The method of claim 1 wherein providing a security services module includes providing a security services module including a cryptographic library.

5. The method of claim 4 wherein providing a cryptographic library includes providing one of the Diffie Hellman, f8, and advanced encryption standard algorithms.

6. The method of claim 1 including providing security services for the protocol stack and application execution environment.

7. A wireless system comprising:
a processor; and
a storage coupled to said processor, said storage storing a separately accessible protocol stack and a security services software module.

8. The system of claim 7 wherein said processor enables the protocol stack to obtain security services from the security services module.

9. The system of claim 7 wherein said system is a wireless telephone.

10. The system of claim 7 wherein said security services software module provides encryption, verification, or authentication services.

11. The system of claim 7 wherein said software module provides a cryptographic algorithm library.

12. The system of claim 11 wherein said cryptographic algorithm is one of the Diffie Hellman, f8, or advanced encryption standard algorithms.

13. The system of claim 7 wherein said module provides security services for the protocol stack and an application execution environment.

14. A cellular telephone comprising:
a processor; and
a first storage coupled to said processor, first said storage storing a protocol stack; and
a second storage coupled to said processor, said second storage storing a security services software module, said protocol stack and module being separately accessible.

15. The telephone of claim 14 wherein said processor enables the protocol stack to obtain security services from the security services module.

16. The telephone of claim 14 wherein said security services software module provides encryption, verification, or authentication services.

17. The telephone of claim 14 wherein said software module provides a cryptographic algorithm.

18. The telephone of claim 17 wherein said cryptographic algorithm is one of the Diffie Hellman, f8, or advanced encryption standard algorithms.

19. The telephone of claim 14 wherein said module provides security services for the protocol stack and an application execution environment.

20. The telephone of claim 14 including a memory device, said first and second storage being part of said memory device.
